(19) United States
(12) Patent Application Publication
(10) Pub. No.: US 2021/0352962 A1
(43) Pub. Date: Nov. 18, 2021

(54) Electronic Cigarette

(71) Applicant: SHENZHEN ACEVAPE TECHNOLOGY CO., LTD., Shenzhen (CN)

(72) Inventor: HENG XU, Shenzhen (CN)

(21) Appl. No.: 16/611,365

(22) PCT Filed: Sep. 11, 2019
(86) PCT No.: PCT/CN2019/105356

§ 371 Date: Nov. 6, 2019

(51) Int. Cl. A24F 40/40; A24F 40/10; A24F 40/60; H01M 50/247

(52) U.S. Cl. CPC A24F 40/40; A24F 40/10; H01M 2220/30; H01M 50/247; A24F 40/60

(57) ABSTRACT

The present disclosure is related to a an electronic cigarette. The electronic cigarette comprises a battery disposed in the housing, a fixer arranged in the housing and above the battery, a step groove disposed on the fixer, a mic plate connected to the side of the fixer near the battery and electrically connected with the positive electrode of the battery. The invention can solve the oil leakage better by completely isolating the fume liquid from the external air, thus ensuring the pure taste of the fume. And, as a top sealing ring is used, the top sealing ring can seal the oil hole as long as the atomizing core pipe is installed when assembling, so as to completely isolate the fume liquid from the external air. Meanwhile, the function of power off switch can be realized by using the atomized core pipe necessary for the assembly of electronic cigarette with conductive bushing, which reduces the cost of purchasing electronic switch and simplifies the assembly process.

### FIELD OF THE INVENTION

The present invention relates to a smoking appliance, and more particularly to an electronic cigarette.

### BACKGROUND OF THE INVENTION

Electronic cigarette is an electronic product that imitates cigarettes, and has the same appearance, taste and feeling as cigarettes. It is a kind of product that can be used by users after the containing nicotine is turned into steam by means of atomization and so on. Because of its good portability, no open fire and environmental protection, electronic cigarettes are favored by many smokers.

An electronic cigarette generally includes an atomizing assembly, a power supply assembly and a housing. The atomizing assembly mentioned above can heat the atomizing liquid stored in the atomizing assembly after electrification, thereby generating aerosol that can be directly sucked by the user. The battery assembly provides electric energy to the atomizing assembly, and the housing is used to accommodate the atomizing assembly and the battery assembly.

The liquid in the traditional atomizer is in contact with the outside air, which will lead to the loss and change of the taste for too long. At the same time, there will be oil leakage in the atomizer. Therefore, there are some atomizers on the market that use oil leakage prevention structure, but the oil will still soak the oil guide cotton in the atomization core. If the cotton wool is soaked in fume for a long time, it will affect the oil guiding performance of the oil guide cotton. Moreover, the existing oil leakage prevention structure on the market is complicated to assemble and high in cost.

Sealing structures in the existing market are assembled and synthesized by several parts, and even some need to be glued to seal without leakage. This makes the operation process cumbersome and easy to be affected by artificial emotions and operation methods, with high cost and increased instability factors.

### SUMMARY OF THE INVENTION

In order to solve the above-mentioned problems, it is an object of the present invention to provide an electronic cigarette, which completely isolates the fume liquid from the external air, guarantees the pure taste of the fume, and can better solve the oil leakage. At the same time, the quality of the product is better protected, so that the battery is not affected by the leakage, and the necessary atomization core is assembled by the electronic fume. With conductive bushing, the switch function can be realized, the cost of purchasing electronic switch can be reduced, and the assembly process can be simplified.

In one embodiment of the present invention, the electronic cigarette comprises a housing, a battery disposed in the housing, a fixer arranged in the housing and above the battery, a step groove disposed on the fixer, a mic plate connected to the side of the fixer near the battery and electrically connected with the positive electrode of the battery, a conductive sleeve connected to the side of the mic plate far from the fixer, a buckle strip formed on the top of the housing, a securing part formed at the bottom of the atomizing cover and matching with the step groove on the securing part, a clamping groove arranged at the junction of the atomizing cover matching with the securing part, a top sealing ring disposed on the top of the atomizing cover, a bottom sealing ring having a groove arranged on the inner wall of the securing part, an atomizing core pipe extended outward through the top sealing ring, and the bottom end inserted in the slot of the bottom sealing ring. Further, the bottom end of the atomizing core pipe is opposite to the conductive sleeve, and an oil inlet is arranged on the atomizing core pipe, a silica gel gasket is arranged at the bottom of the atomizing core pipe and matches with the slot on the bottom sealing ring, and a heating wire is arranged in the atomizing core pipe. The positive and negative pins of the heating wire extend outward through the silica gel gasket. The negative pins of the heating wire are electrically connected with the output negative polar line of the mic plate, and the negative pins of the heating wire are electrically connected with the atomizing core pipe.

In one embodiment of the present invention, the positive and negative electrodes of the battery are conductive when the atomizing core pipe is offset with the conductive sleeve, and the top seal ring is wrapped into the oil hole when the atomizing core pipe is separated from the conductive sleeve.

In one embodiment of the present invention, the fixer is made of plastic material.

In one embodiment of the present invention, the bottom of the housing comprises a breathing hole.

In one embodiment of the present invention, the top of the atomizing cover comprises a silica gel sleeve matched with the atomizing core pipe.

In one embodiment of the present invention, a light guide column is embedded on the outer housing.

Compared with the prior art, the present invention provides an electronic cigarette, which has the following beneficial effects:

(1) The present invention has the following advantages: the oil inlet hole of the atomizing core pipe is sealed by the top silica gel sealing ring, the fume oil cannot enter the oil inlet hole, and the fume liquid in the atomizing cover is completely separated from the external air. At the same time, it plays the role of sealing without leakage, better protects the quality of the product, and makes the battery not affected by leakage, thus greatly guaranteeing that the fume oil cannot enter the oil inlet hole and ensuring the performance of the product.

(2) The present invention adopts the top sealing ring and the bottom sealing ring, and when assembling, as long as the atomizing core pipe is mounted, the top sealing ring will seal the oil hole, so that the fume liquid can be completely isolated from the external air. Thus, the number of assemblies is small, the cost of material and manual assembly is low, and the product performance is stable.

(3) The present invention realizes the stability of the assembly of the atomizing cover and the outer housing by adopting the mutually matched securing part and fixers, clamping grooves and clamps.

(4) The present invention realizes the function of power-off switch by controlling the contact and separation between the atomized core tube and the conductive sleeve. Compared with the electronic cigarette controlled by the electronic switch components, the present invention uses the atomized core tube necessary for the assembly of the electronic cigarette to cooperate with the conductive sleeve to realize the power-off switch. It can reduce the cost of purchasing electronic switches, simplify the assembly process, avoid the phenomenon of automatic operation of products affected by external factors (such as strong vibration, blowing on products), solve the problem of battery self-consumption and PCB board self-consumption, and greatly ensure the performance of products, even long-term operation, transportation and storage will not cause power loss to this product. To a large extent, it guarantees the performance and quality of the product, so that consumers can better experience the high performance of the product.

Various other objects, advantages and features of the present invention will become readily apparent from the ensuing detailed description, and the novel features will be particularly pointed out in the appended claims.

### BRIEF DESCRIPTION OF FIGURES

The following detailed descriptions, given by way of example, and not intended to limit the present invention solely thereto, will be best be understood in conjunction with the accompanying figures:

FIG. 1 is an explosive view of an electronic cigarette according to the present invention;

FIG. 2 is a schematic diagram of an atomizing cover according to the present invention;

FIG. 3 is a schematic diagram of a housing according to the present invention;

FIG. 4 is a schematic diagram of the electronic cigarette according to the present invention; and

FIG. 5 is a schematic diagram of a housing according to another preferred embodiment of the present invention.

### DETAILED DESCRIPTION OF THE EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

The drawings and description are to be regarded as illustrative in nature and not restrictive. Like reference numerals designate like elements throughout the specification. In addition, the size and thickness of each component shown in the drawings are arbitrarily shown for understanding and ease of description, but the present invention is not limited thereto.

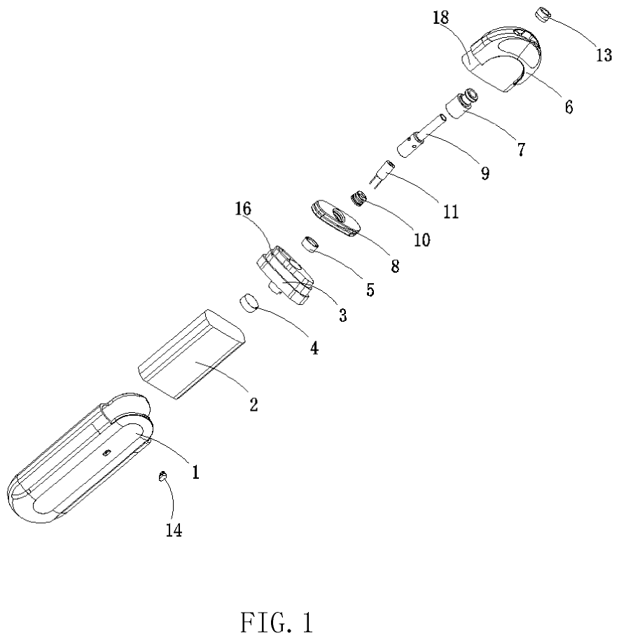

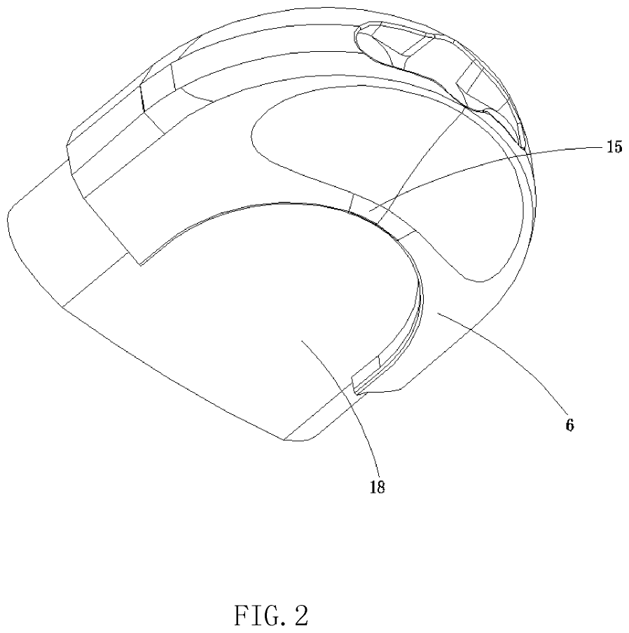

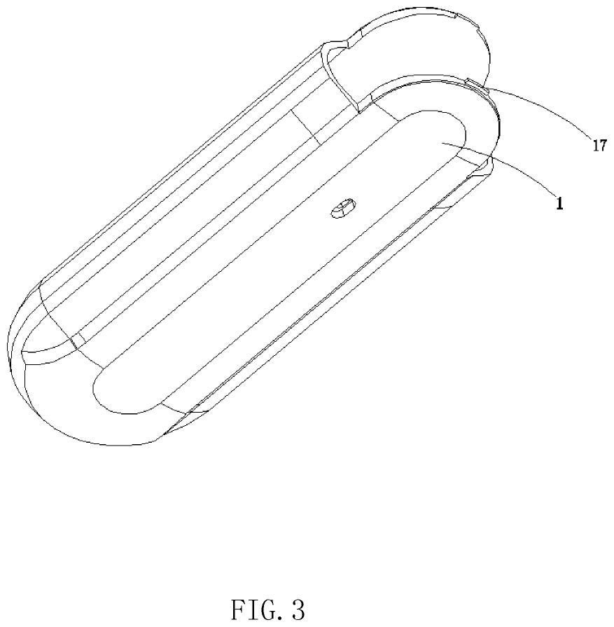

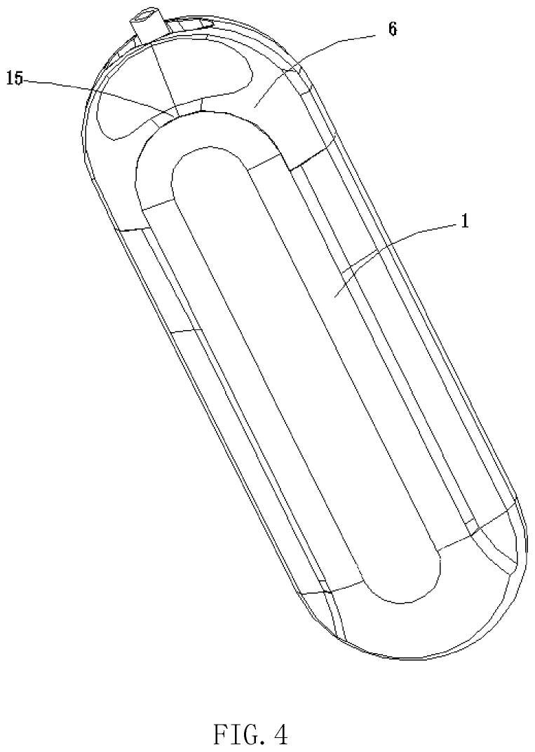

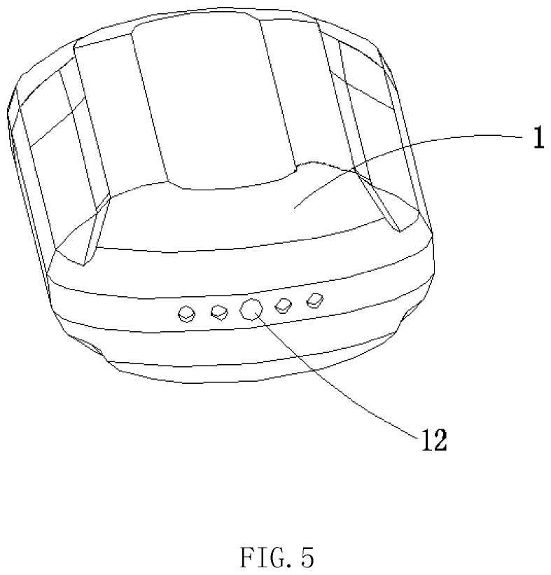

As shown in FIGS. 1 to 5, an electronic cigarette according to the present invention comprises a housing 1, a battery 2 disposed in the housing 1, a fixer 3 arranged in the housing 1 and above the battery 2, a step groove 16 disposed on the fixer 3, a mic plate 4 connected to the side of the fixer 3 near the battery 2 and electrically connected with the positive electrode of the battery, a conductive sleeve 5 connected to the side of the mic plate 4 far from the fixer 3, an atomizing cover 6 clamped with the housing 1, a buckle strip 17 formed on the top of the housing 1, a securing part 18 formed at the bottom of the atomizing cover 6 and matching with the step groove 16 on the securing part 18, a clamping groove 15 arranged at the junction of the atomizing cover 6 matching with the securing part 18, a top sealing ring 7 disposed on the top of the atomizing cover 6, a bottom sealing ring 8 having a groove arranged on the inner wall of the securing part 18, an atomizing core pipe 9 extended outward through the top sealing ring 7, and a bottom end inserted in the slot of the bottom sealing ring 8. Further, the bottom end of the atomizing core pipe 9 is opposite to the conductive sleeve 5, and an oil inlet is arranged on the atomizing core pipe 9, a silica gel gasket 10 is arranged at the bottom of the atomizing core pipe 9 and matches with the slot on the bottom sealing ring 8, and a heating wire 11 is arranged in the atomizing core pipe 9.

The positive and negative pins of the heating wire 11 extend outward through the silica gel gasket 10. The negative pins of the heating wire 11 are electrically connected with the negative electrode of the mic plate 4, and the negative pins of the heating wire 11 are electrically connected with the atomizing core pipe 9.

In the embodiment, the atomizing cover 6 and the top are dense. The chamber formed by sealing ring 7 and bottom sealing ring 8 is used for the storage of fume, and the top of atomizing cover 6 is provided with an oil injection port.

In the embodiment, the positive and negative electrodes of battery 2 are conducting when the atomized core tube 9 is offset with the conductive sleeve 5, and the top seal ring 7 is wrapped in the oil inlet hole when the atomized core tube 9 is separated from the conductive sleeve 5.

In the embodiment, fixer 3 is made of plastic material, and the bottom of the housing 1 is provided with a breathing hole 12 to heat the battery 2. Further, the top of the atomizing cover 6 is provided with a silica gel sleeve 13 matched with the atomizing core pipe 9 to improve the sealing performance of the atomizing core pipe 9 and the atomizing cover 6.

In the embodiment, a light guide column 14 is embedded on the outer housing 1.

During assembling the electronic cigarette, the buckle strip 17 is clipped into the clamping groove 15, and the securing part 18 and the step groove 16 are embedded in place to complete the butt joint of the atomizing cover 6 and the outer housing 1. At this time, there is a gap between the fixer 3 and the bottom sealing ring 8.

When assembling the atomizing assembly, only the top of the atomizing core pipe 9 is installed on the top sealing ring 7, and the bottom of the atomizing core pipe 9 is inserted on the bottom. In the groove of seal ring 8, the top seal ring 7 seals the oil inlet of atomizing core pipe 9 under non-working condition. Fume liquid can be completely separated from external air; at the same time, fume oil can be isolated and sealed in addition to oil cotton, ensuring product quality and eliminating oil leakage, so that the number of assemblies is small, the cost of material and manual assembly is low.

After assembly, electronic cigarette in non-use state will not be used at the bottom of the atomizing core pipe 9. At the same time, the oil inlet hole of the atomizing core pipe 9 is sealed by the top sealing ring 7. Fume oil cannot enter into the oil inlet hole, and the fume liquid in the atomizing cover 6 is completely isolated from the external air.

Because the top sealing ring 7 and bottom sealing ring 8 are adopted, the product is stable, and it also plays the role of sealing without leakage, so as to better protect the quality of the product, so that the battery 2 is not affected by leakage. When used, the lower pressure atomizing core pipe 9 makes the product stable. The atomizing core pipe 9 enters the conductive sleeve 5, and the fume stored in the atomizing cover 6 enters the inner cavity of the atomizing core pipe 9 through the oil inlet hole on the atomizing core pipe 9.

At the same time, the atomizing core pipe 9 moves downward into the conductive sleeve 5 of hardware material. The positive and negative poles of battery 2 can be turned on. At this time, the heating wire 11 will work to heat the fume in the atomizing core pipe 9, and the smoke will come out through the suction nozzle of the atomizing core pipe 9. By using the atomizing core pipe 9 necessary for the assembly of electronic cigarette and the conductive sleeve 5, the power-off switch function can be realized, the cost of purchasing electronic switches can be reduced and simplified.

The assembly process, atomizing core pipe 9 realizes the function of power-off switch, avoids the occurrence of automatic operation of the product, solves the problem of battery self-consumption and PCB board self-consumption, greatly guarantees the performance of the product, even long-term transportation and storage will not cause power loss of the product.

To a great extent, it guarantees the performance and quality of the product, so that consumers can better experience the high performance of the product. Even the short-term and long-term transportation storage will not cause power loss to the product. Even the short-term and long-term transportation storage will not cause power loss to the product and help to improve the service life.

After the use, pull up the atomizing core pipe 9 to separate it from the conductive sleeve 5, power off the battery, and realize the function of power off. At the same time, the top seal ring 7 wraps the oil hole, effectively avoiding the contact between the fume and the external air, preventing leakage, and ensuring the pure quality of the fume.

In addition, in the specification, unless explicitly described to the contrary, the word “comprise” and variations such as “comprises” or “comprising” will be understood to imply the inclusion of stated elements but not the exclusion of any other elements.

The present invention has been described with a preferred embodiment thereof and it is understood that many changes and modifications to the described embodiment can be carried out without departing from the scope and the spirit of the invention that is intended to be limited only by the appended claims.

What is claimed is:

1. An electronic cigarette, comprising:
a housing;
a battery, disposed in the housing;
a fixer, arranged in the housing and above the battery;
a step groove, disposed on the fixer;
a mic plate, connected to the side of the fixer near the battery and electrically connected with the positive electrode of the battery;
a conductive sleeve, connected to the side of the mic plate far from the fixer;
an atomizing cover, clamped with the housing;
a buckle strip, formed on the top of the housing;
a securing part, formed at the bottom of the atomizing cover and matching with the step groove on the securing part;
a clamping groove, arranged at the junction of the atomizing cover matching with the securing part;
a top sealing ring, disposed on the top of the atomizing cover;
a bottom sealing ring, having a groove arranged on the inner wall of the securing part;
an atomizing core pipe, extended outward through the top sealing ring; and
a bottom end, inserted in the slot of the bottom sealing ring;
wherein, the bottom end of the atomizing core pipe is opposite to the conductive sleeve, and an oil inlet is arranged on the atomizing core pipe, a silica gel gasket is arranged at the bottom of the atomizing core pipe and matches with the slot on the bottom sealing ring, and a heating wire is arranged in the atomizing core pipe.

2. The electronic cigarette according to claim 1, wherein the positive and negative electrodes of the battery are conductive when the atomizing core pipe is offset with the conductive sleeve, and the top sealing ring is wrapped in the oil hole when the atomizing core pipe is separated from the conductive sleeve.

3. The electronic cigarette according to claim 2, wherein the fixer is made of plastic material.

4. The electronic cigarette according to claim 3, the bottom of the housing comprises a breathing hole.

5. The electronic cigarette according to claim 4, further comprising a silica gel sleeve, matching the atomizing core tube, arranged at the top of the atomizing cover.

6. The electronic cigarette according to claim 1, further comprising a light guide column embedded on the outer housing.
